(19) United States
(12) Patent Application Publication
(10) Pub. No.: US 2017/0283654 A1
(43) Pub. Date: Oct. 5, 2017

(54) AQUEOUS COATING MATERIALS

(71) Applicant: Wacker Chemie AG, Munich (DE)

(72) Inventors: Frank SANDMEYER, Burgkirchen (DE); Albert HAUSBERGER, Kienberg (DE); Martin SEBALD, Haiming (DE)

(73) Assignee: Wacker Chemie AG, Munich (DE)

(21) Appl. No.: 15/507,446

(22) PCT Filed: Jul. 13, 2016
(86) PCT No.: PCT/EP2016/066593

§ 371 Date: Feb. 28, 2017

(30) Foreign Application Priority Data
Jul. 30, 2015 (DE) 10 2015 214 501.8

(51) Int. Cl. C09D 183/04; C09D 7/00

(52) U.S. Cl. CPC C09D 183/04; C09D 7/001

(57) ABSTRACT

Silicone resin dispersions containing at least one silicone resin having at least two differently substituted T units are used in aqueous coating materials producible therefrom for mineral building materials, wood or metal. The aqueous coating materials exhibit good hydrophobicity without beading, low water permeability, and acquire these properties rapidly after application.

### CROSS REFERENCE TO RELATED APPLICATIONS

This application is the U.S. National Phase of PCT Appln. No. PCT/EP2016/066593 filed Jul. 13, 2016, which claims priority to German Application No. 10 2015 214 501.8 filed Jul. 30, 2015, the disclosures of which are incorporated in their entirety by reference herein.

### BACKGROUND OF THE INVENTION

### 1. Field of the Invention

The invention relates to silicone resin dispersions comprising at least one silicone resin having at least two differently substituted T units and to aqueous coating materials producible therefrom for mineral building materials, wood or metal.

### 2. Description of the Related Art

Protection of building materials from the damaging effect of water is critically important to long-term preservation of the performance capacity and hence the perennial integrity of a building material. Reflecting this importance, there are numerous methods by which building materials are protected from water. Within the family of these protective measures, a particularly prominent position is occupied by coating systems and impregnation systems, since they are simple to apply and therefore offer particular advantages to the user. Coatings, moreover, are required to be environmentally friendly and sustainable, thus being free from toxicologically objectionable or eco-unfriendly substances. They are required to possess good substrate adhesion and good cohesive qualities. Furthermore, they are to be permeable to water vapour while at the same time effectively blocking the passage of liquid water. Construction coatings, furthermore, must themselves be long-lived and aesthetically appealing.

For achieving this profile of properties, the use of silicone resins as binders or co-binders in construction paints has often been proposed.

EP1034209B1 teaches the use of aqueous silicone resin dispersions as construction coating compositions. The active ingredient in the silicone resin dispersions comprises silicone resins which are composed primarily of T units and which may also include M, D and Q units. They are hydroxy-functional, necessarily containing at least 0.05 wt % of hydroxyl groups. The dispersions further comprise other components serving, among other purposes, for curing and emulsification of the resin. The silicone resin dispersions of the invention are used for the formulation of water-repellent construction paints.

U.S. Pat. No. 5,316,799 describes a hydrophobic impregnating composition which comprises a silane or linear siloxane and which is employed as a mixture with a paint. The system as a whole is water-repellent and hence superficially hydrophobic.

EP0606671A1 describes organopolysiloxane resin-, filler- and alkoxysilane- and optionally alkoxysiloxane-containing emulsions which are applied to mineral building materials for the purpose of hydrophobilizing them. The silicone resins are MQ or MDQ resins. The fillers have a specific surface area of at least 40 m²/g and are added in small quantities.

EP0616989A1 teaches a hydrophobizing agent as an aqueous impregnating emulsion for mineral building materials, comprising a mixture of alkylalkoxysilanes and alkylalkoxysiloxanes in a mixing ratio of 0.5:1 to 0.98:1. The alkylalkoxysilanes are substituted by alkyl radicals of different lengths. The alkylalkoxysiloxanes are composed of alkyl-substituted T and D units. Different alkyl substituents are allowed on the respective silicone units. In view of the inaccurate disclosure of the alkylalkoxysiloxane unit, its structure is not clearly apparent, but the information provided does suggest that the T units have alkyl substituents more than 3 C atoms in length and the D units may be substituted with mixtures of short-chain and long-chain alkyl radicals. There is no evidence of two T units with different alkyl substitution. Included in the mixture in accordance with the invention are alkyltrialkoxysilanes, and so in principle there are two differently substituted silicon species in the mixture, each surrounded by three oxygen atoms and carrying different alkyl radicals. The presentation form, however, is not a homogeneous molecule in which these two units are united with one another by chemical combination, but is instead a mixture of the two different silicon species. The aqueous impregnating emulsion of the invention that is obtained produces a water barrier effect by development of surface-hydrophobicity.

EP1844120B1 teaches high-viscosity aqueous emulsions as hydrophobizing agents for mineral building materials, containing 50%-90% of functional alkoxysilanes and/or their oligomers and/or organoalkoxysiloxanes. If the functional alkoxysilanes are alkyl-substituted, the alkyl radicals comprise at least 3 C atoms. The organoalkoxysilanes are linear siloxanes which may contain an Si—C-bonded radical, it being possible in principle for there to be differently alkyl- or aralkyl-substituted silicon atoms. On each silicon atom on the chain, moreover, there is an alkoxy group, with two such groups being bonded at each of the chain ends. As a result of this substitution pattern, a chain structure composed exclusively of D units is formed. Accordingly, the organoalkoxysiloxanes have a very high alkoxy functionality. There is no limit on the viscosity of the high-viscosity emulsions, but the use examples show that the systems in question are paste-like. The emulsions described have a superficial hydrophobizing effect.

EP0098940A2 teaches aqueous preparations comprising polyorganosiloxane compounds. The polyorganosiloxanes are alkoxy-rich partial hydrolysates optionally of different alkoxysilanes, it being possible for the silicon atoms to be substituted by different Si—C-bonded alkyl radicals or aralkyl radicals and/or mixtures thereof. The aqueous preparations are prepared by adding an aqueous preparation of polyvinyl alcohol to the partial silane hydrolysate and then subjecting the system to strong acidification. Under these conditions, the partial hydrolysates undergo further hydrolysis and condensation and, in so doing, form considerable quantities of alcohol, which are included in the end product. As a result, aqueous preparations with possibly critical flash points are produced, which inevitably contain alcohols, which may possibly be toxic, in the form of methanol, for example. The siloxane condensates are poorly defined. Accordingly, EP0098940 also gives no information on the composition of the siloxane condensates after the production of the aqueous preparations. The aqueous preparations are said to be stable, but to the skilled person it is clear that a criterion for the stability of such a preparation is the formation of alcohol during the storage period. Since alcohols in unknown quantity are produced during the production process itself, the stability concept here is incomprehensible and arbitrary. Coating materials are given as a possible application of the aqueous preparations; in view of the inherent toxicological, safety-related and environmental disadvantages, the suitability of the aqueous preparations of the invention is highly questionable, if not completely out of the question.

EP0287085 relates to hydrophobizing, aqueous, silicon-containing coating systems which comprise as their binder a mixture of organopolysiloxane and ethylene-vinyl chloride copolymers. Example 1 describes one such hydrophobizing silicone resin paint, which comprises a silicone resin containing not only methyl groups but also isooctyl groups as Si—C-bonded radicals on monoalkylsiloxane units. Since the rest of the substitution pattern is not disclosed, all that can be inferred is that these are units which possess only one silicon-bonded alkyl group. All that is otherwise disclosed regarding this organopolysiloxane is that there is a hydrophobizing aqueous coating material.

In the prior art outlined above, the silicone components are always used in order to bring about hydrophobic properties, more particularly superficial hydrophobic properties, which are commonly manifested in a beading effect. Tests of this kind are occasionally employed for verification of the hydrophobicity claimed. This means that water is unable to wet the surface, instead concentrating into droplets. It is common knowledge and easily understood that a compact droplet evaporates more slowly than a film of the same amount of water present in a form spread uniformly over a relatively large area. As a result, while the pronounced hydrophobicity of the silicone components does prevent the passage of water through a coating or impregnation, the surface remains moist for longer at those areas at which the water collects in droplets, and thus offers a relatively easy point of attack for microorganisms which are able to utilize the locations of increased moisture for their growth. In this way, pronounced hydrophobicity leads to an increased risk of microorganism infestation at locations where the evaporation of the moisture from the surface is not promoted by particularly advantageous conditions such as wind and heat, and results, therefore, in damage to the surface and to loss of its protective and of its aesthetic qualities.

Nevertheless, an extremely positive property of the hydrophobicity is to prevent the passage of liquid water through the respective coating, so that the underlying substrate remains dry and thus retains its performance capacity over the long term. This applies not only to mineral substrates but also to wood and metal. In the case of the latter, the water barrier effect makes a key contribution to preventing corrosion. A combination of a fairly hydrophilic surface yet with good water blocking effect on the part of the coating would be ideal—in other words, moisture management rather than simple hydrophobicity. Since such properties are mutually exclusive, it is not obvious that they can be achieved with one product and, in particular, by an application of only one kind of coating material. The expectation would instead be of such a combination of at least two-coat application using different coating materials, with each one taking on one of the two functions, water barrier effect and surface hydrophilicity.

Furthermore, the applications cited above refer to the slow curing of the silicone resins, and in some cases recommend catalysts and activators to accelerate this curing, such as in EP1034209B1. During the cure time of the siloxane components, the silicone does not exhibit its full performance capacity in respect either of mechanical qualities or of water barrier effect.

Another disadvantage of the siloxane dispersions from the prior art is the fact that the emulsifiers which are needed in order to maintain the silicone stably in the aqueous phase remain in the paint following its application and, on account of their hydrophilicity, reduce the water barrier effect of the paint in the period immediately following application of the paint. Only after the emulsifiers have been washed out do such paints attain their full water barrier effect.

### SUMMARY OF THE INVENTION

It was an object of the present invention, therefore, to provide aqueous siloxane dispersions which do not have the abovementioned disadvantages—in other words, dispersions which, not least immediately after paint application, display the full water barrier effect of the paint, and also the full mechanical performance, with the overall level of the performance capacity of the paint fully conforming to the other requirements. The siloxane dispersions here are to result in coating materials which do not have a hydrophobic surface, but instead allow water to spread out to an extremely thin film and thus which promote its rapid evaporation, in order to keep the surface sustainably dry. In other words, they are in no way to result in a beading effect. At the same time, they are to prevent effectively the passage of water through the coating material film, and are to provide all of these properties after just a single coat application through the use of only one kind of coating material.

Surprisingly it has been found that certain silicone resins in the form of aqueous siloxane dispersions achieve this object. This is especially surprising on account of the fact that similar silicone resins are already known in the prior art, but all have consistently hydrophobic properties and result correspondingly in hydrophobic coating materials. The silicone resins of the invention and dispersions thereof are therefore a specific selection of silicone resins which run counter to those in the prior art and exhibit entirely unexpected properties.

### DETAILED DESCRIPTION OF THE PREFERRED EMBODIMENTS

In the present text, substances are characterized by reporting of data obtained by means of instrumental analysis. The measurements involved either are carried out in accordance with publicly available standards, or are determined according to specially developed methods. In order to ensure that the teaching given is clear, the methods used are reported here:

### Viscosity:

Unless otherwise reported, the viscosities are determined by rotational-viscosimetric measurement in accordance with DIN EN ISO 3219. Unless otherwise reported, all viscosity reports are valid at 25° C. and atmospheric pressure of 1013 mbar.

### Refractive Index:

The refractive indices are determined in the wavelength range of visible light—unless otherwise reported, at 589 nm at 25° C. under atmospheric pressure of 1013 mbar in accordance with standard DIN 51423.

### Transmission:

The transmission is determined by UV VIS spectroscopy. An example of a suitable instrument is the Jena Specord 200 analytical system.

The measurement parameters used are as follows: range: 190-1100 nm,

step length: 0.2 nm, integration time: 0.04 s, measurement mode: step operation. First there is a reference measurement (background). A quartz plate mounted on a sample holder (quartz plate dimensions: H×W approx. 6×7 cm, thickness approx. 2.3 mm) is inserted into the sample beam path and measured against air.

This is followed by the sample measurement. A quartz plate mounted on the sample holder and with sample applied—layer thickness of applied sample approx. 1 mm—is placed into the sample beam path and measured against air. Internal computation relative to background spectrum yields the transmission spectrum of the sample.

### Molecular Compositions:

The molecular compositions are determined by means of nuclear magnetic resonance spectroscopy (regarding the terminology see ASTM E 386: High-resolution nuclear magnetic resonance spectroscopy (NMR): Terms and symbols), with measurement of the ¹H nucleus and of the ²⁹Si nucleus.

### Description of ¹H NMR Measurement

Solvent: CDCl₃, 99.8% d

Sample concentration: about 50 mg/l ml CDCl₃ in 5 mm NMR vial

Measurement without addition of TMS, spectral referencing of residual CHCl₃ in CDCl₃ at 7.24 ppm

Spectrometer: Bruker Avance I 500 or Bruker Avance HD 500

Probe head: 5 mm BBO probe head or SMART probe head (from Bruker)

### Measuring Parameters:

Pulprog=zg30

TD=64 k

NS=64 or 128 (depending on the sensitivity of the probe head)

SW=20.6 ppm

AQ=3.17 s

D1=5 s

SFO1=500.13 MHz

O1=6.175 ppm

### Processing Parameters:

SI=32 k

WDW=EM

LB=0.3 Hz

Depending on the type of spectrometer used, individual adjustments of the measurement parameters may be required.

### Description of ²⁹Si NMR Measurement

Solvent: C₆D₆ 99.8% d/CCl₄ 1:1 v/v with 1 wt % Cr(acac)₃ as relaxation reagent
Sample concentration: about 2 g/1.5 ml solvent in 10 mm NMR vial
Spectrometer: Bruker Avance 300
Probe head: 10 mm 1H/13C/15N/29Si glass-free QNP probe head (from Bruker)

### Measuring Parameters:

Pulprog=zgig60

TD=64 k

NS=1024 (depending on the sensitivity of the probe head)

SW=200 ppm

AQ=2.75 s

D1=4 s

SFO1=300.13 MHz

O1=−50 ppm

### Processing Parameters:

SI=64 k

WDW=EM

LB=0.3 Hz

Depending on the type of spectrometer used, individual adjustments of the measurement parameters may be required.

### Molecular Weight Distributions:

Molecular weight distributions are determined as weight averages Mw and as number averages Mn, using the method of gel permeation chromatography (GPC or size exclusion chromatography (SEC)) with polystyrene standard and refractive index (RI) detector. Unless otherwise noted, THF is used as mobile phase and DIN 55672-1 applies. The polydispersity is the Mw/Mn quotient.

### Glass Transition Temperatures:

The glass transition temperature is determined according to differential scanning calorimetry (DSC) according to DIN 53765, perforated crucible, heating rate 10 K/min.

The invention thus pertains to aqueous silicone resin dispersions comprising

(A) 10-70 wt % of at least one silicone resin liquid at room temperature (25° C.), the liquid silicone resin
comprising at least 50% of repeating units of the formula (1)

R¹(R²O)_{b}SiO_{(3-b/2)} (1)
where
R¹ denotes C1-C20 hydrocarbyl radicals which carry no or at least one heteroatom,
R² denotes C1-C6 hydrocarbyl radicals or a hydrogen radical, and
b has a value of 0, 1 or 2,
and 0 to at most 50% of repeating units of the formula (2),

R⁸_{c}(R²O)_{d}SiO_{(4-c-d/2)} (2),
where
R⁸ independently at each occurrence denotes C1-C20 hydrocarbyl radicals,
R² has the definition stated above,
c may be 0, 2 or 3,
d may be 0, 1, 2 or 3,
with the proviso that c+d 3,
characterized in that
   the silicone resins comprise at least 2 repeating units of the formula (1), which are different from one another, in a ratio of 1:100 to 100:1, and which carry at least 2 radicals R¹ which are different from one another and which differ from one another in their length or size by at least one hydrocarbon unit,
   5% to 35% of all silicon-bonded substituents in formula (1) are of the subformula (R²O) in which R² is a C1-C6 hydrocarbyl radical,
   at most 5% of all silicon-bonded substituents in formula (1) are of the subformula (R²O) in which R² is a hydrogen radical,
   in at least 5% of all the repeating units of the formula (1), b=0,
   in at least 5% of all the repeating units of the formula (1), b=1,
   in at most 25% of all the repeating units of the formula (1), b=2

B) 0-2 wt % of at least one organopolysiloxane comprising SiC-bonded radicals with basic nitrogen, with the proviso that its amine number is at least 0.01,

(C) 0.1-30 wt % of at least one dispersing assistant,

(D) 10-70 wt % of water,

(E) 0.01-10 wt % of at least one auxiliary, and

(F) 0 to 6 wt % of at least one alkylalkoxysilane whose alkyl radicals are C1-C20 alkyl radicals and whose alkoxy groups consist of oxygen-bonded C1-C6 alkyl radicals.

The silicone resin dispersion preferably possesses a viscosity of between 10 and 50,000 mPas, more preferably 20-10,000 mPas, and most preferably 20-5000 mPas at 25° C.

Through appropriate selection of the preparation components and their relative amounts, the silicone resin dispersions of the invention can also be formulated in such a way that they result, rather than liquid emulsions, in paste-like aqueous preparations which have the form of a cream and possess viscosities of more than 100,000 mPas at 25° C.

The silicone resin dispersions of the invention are produced by the known, prior-art methods. From the silicone resin dispersions of the invention, by methods according to the prior art, aqueous coating materials of the invention are likewise obtained. The aqueous coating materials of the invention are produced by known methods from the prior art, with the characteristic feature that at least one silicone resin dispersion of the invention is admixed.

In a method for coating and for obtaining the advantageous properties of the coating materials of the invention on mineral building materials, wood or metal, the aqueous coating material of the invention is applied to mineral building materials, wood or metal.

The most important coating materials of the invention are paints, stains, varnishes and renders and are applied to mineral building materials, wood or metal. A particular characteristic of the silicone resin dispersions of the invention is that they produce aqueous coating materials for mineral building materials, wood or metal, characterized in that the water barrier effect of the coating materials even without the emulsifiers having been washed out attains a value in class 3 according to DIN EN 1062-3 (<0.1 kg/m² h^{0.5}). The mechanical strength tested according to DIN 53778-2 4 days after application attains a value of >10,000 abrasion cycles.

Moreover, no beading effect is obtained, indicating surface hydrophobicity, but instead a water droplet which is placed onto the surface spreads over that surface, but without entering into or passing through the paint coat. Accordingly, the coating materials of the invention produce coatings which at the same time allow water to spread on the surface and have a pronounced water barrier effect. The aqueous coating materials are preferably paints and stains, more particularly paints.

The coating materials suitable for the purposes of the invention are either supplied in dry form, but applied in the form of a water-containing preparation, such as powder paints and pulverulent dry renders, or are wet, such as paste-like, water-containing paints, examples being silicone resin paints, silicate paints and emulsion paints, or such as paste-like, water-containing renders, examples being synthetic resin renders and silicone resin renders.

The impregnating coating compositions suitable for the purposes of the invention can be classified according to application thickness, and are applied thickly, such as renders in the millimetre to centimetre range, or are applied thinly, such as hiding paints and varnishes in the 100 μm to 1 millimetre range, or translucently to hidingly such as impregnating materials and low-build and high-build stains in the 3 μm to 100 μm range.

The impregnating coating materials suitable for the purposes of the invention may be used both inside and out, preferably outdoors. Examples of coating materials of the invention used on buildings are silicate renders, dry renders, brush-applied fillers, reinforcing compounds, filling compounds, synthetic resin renders, mineral renders, silicone resin renders and synthetic resin-bound coatings. Preferred examples are interior paints, masonry paints, mineral paints, emulsion paints, silicone resin paints, silicone masonry paints, stains, varnishes, silicate emulsion paints, silicate paints, lime paints, and lime emulsion paints.

### Silicone Resins (A)

Examples of hydrocarbyl radicals R¹ are alkyl radicals, particularly C1-C3-alkyl radicals, and also C2-C20 alkyl radicals, and alkenyl radicals such as the vinyl, allyl, n-5-hexenyl, 4-vinylcyclohexyl and the 3-norbornenyl radical; aryl radicals such as the phenyl-, biphenylyl, naphthyl and anthryl and phenanthryl radical; alkaryl radicals such as o-, m- and p-tolyl radicals, xylyl radicals and ethylphenyl radicals; aralkyl radicals such as the benzyl radical, and the alpha- and the beta-phenylethyl radicals. Particularly preferred are the C1-C20-alkyl radicals and aryl radicals, not substituted by heteroatoms. In particular, C1-C16 alkyl radicals without heteroatoms, particularly the methyl, the ethyl, the n-octyl and the isooctyl radical.

The ratio of the two different repeating units (1) to one another is 1:100 to 100:1, preferably 1:99-99:1, more preferably 1:97 to 97:1, more particularly 1:96 to 96:1.

It is preferred, and has proved to be particularly advantageous, if the repeating unit (1) having the more carbon-rich substituent is present at not more than 75 mol % of all the repeating units of the formula (1). Conversely this means that the repeating unit (1) having the less carbon-rich substituent is present at not less than 25 mol % of all the repeating units of the formula (1). In one particularly preferred embodiment of the invention, the repeating units of the formula (1) having the less carbon-rich substituent are present in the majority, i.e. more than 50 mol % of all the repeating units of the formula (1).

Examples of particularly preferred combinations of radicals R¹ are such that R¹ is selected such that at least one C1-C20 alkyl radical without heteroatoms is combined with at least one aryl radical, such as phenyl and methyl radicals, phenyl and ethyl radicals, isooctyl and phenyl radicals, and n-octyl and phenyl radicals. Further preferred combinations of two different C1-C16 alkyl radicals without heteroatoms are the n-butyl radical and the ethyl radical, the n-butyl radical and the methyl radical, the ethyl radical and the methyl radical, the n-octyl radical and the methyl radical, the isooctyl radical and the methyl radical, the n-octyl radical and the ethyl radical, the isooctyl radical and the ethyl radical, wherein the combination of phenyl radical and methyl radical, ethyl radical and methyl radical, isooctyl radical and methyl radical, ethyl radical and isooctyl radical, and phenyl radical and isooctyl radical, are particularly advantageous. A combination of methyl and isooctyl radicals and of methyl and phenyl radicals as the two different radicals R¹ has proved to be particularly effective. In the case of the combination of isooctyl radical and methyl radical, there are preferably more repeating units of the formula (1) that carry methyl radicals than those that carry isooctyl radicals. The ratio of the number of repeating units of the formula (1) which carry methyl radicals to the number of repeating units of the formula (1) which carry isooctyl radicals is preferably 51:49 to 99:1, more preferably 55:45 to 98:2, more particularly 60:40 to 98:2. Ratios of 60:40, 70:30, 90:10 and 95:5 have proved to be particularly effective.

In the case of the combination of phenyl radicals and methyl radicals, the following ratios of the number of repeating units of the formula (1) which carry methyl radicals to the number of repeating units of the formula (1) which carry phenyl radicals are particularly preferred: 98:2 to 10:90, more preferably 98:2 to 20:80, more particularly 98:2 to 30:70. Ratios which have proved to be particularly advantageous are those in the ranges 98:2-70:30 and 25:75-40:60, especially 97:3, 95:5, 90:10, 70:30, 35:65 and 45:55.

Also possible and in accordance with the invention is the combination of more than two different radicals. In that case, the preferred ratios specified above for the combination of two different radicals are valid mutatis mutandis if the more carbon-richly substituted repeating units are added together and made into a ratio relative to the repeating unit which carries the smallest and/or the least carbon-rich substituent; in the manner described above, a distinction is made between combinations involving aromatic substituents and those not involving aromatic constituents. In the case where there are more than two different repeating units of the formula (1), as well, preferred combinations are those of methyl, ethyl, phenyl, n-butyl, n-octyl, isooctyl, more particularly of methyl, ethyl, phenyl and isooctyl, especially of methyl, phenyl and isooctyl.

Examples of the radicals R² are the methyl, ethyl, n-propyl, isopropyl, n-butyl, sec-butyl, and tert-butyl radicals; pentyl radicals such as the n-pentyl radical, and hexyl radicals, such as the n-hexyl radical; the ethyl radicals are particularly preferred.

Preferably (A) is present in the silicone resin dispersion at from 10 to 65 wt %, more preferably from 25 to 60 wt %.

### Organopolysiloxanes (B)

The organopolysiloxanes (B) are preferably those composed of units of the general formula (4)

R³ₐ*R⁴_{b}*(OR⁵)_{c}*SiO_{(4-a*-b*-c*)/2} (4)

in which
R³ denotes identical or different monovalent, halogen-substituted or non-halogen-substituted, SiC-bonded C₁-C₂₀ hydrocarbyl radicals which are free of basic nitrogen,
R⁴ denotes identical or different monovalent, halogen-substituted or non-halogen-substituted, SiC-bonded C₁-C₃₀ hydrocarbyl radicals containing basic nitrogen,
R⁵ identically or differently is a hydrogen atom or C₁-C₆ alkyl radicals,
a* is 0, 1, 2 or 3,
b* is 0, 1, 2 or 3, on average at least 0.05, and
c* is 0, 1, 2 or 3,
   with the proviso that the sum of a*, b* and c* is not more than 3 and that the amine number of the organopolysiloxane (B) is at least 0.01.

The amine number identifies the number of ml of 1N HCl required to neutralize 1 g of organopolysiloxane (B). The amine number of organopolysiloxane (B) is preferably at least 0.1, more preferably at least 0.2, and preferably not more than 8, more preferably not more than 4.

Examples and preferred examples of the radical R³ are the examples already disclosed above for radical R¹. Particularly preferred for the radical R³ are the methyl radical and the isooctyl radical.

The radical R⁴ is preferably a radical of the general formula (3)

R⁶₂NR⁷ (3)

where

R⁶ may be identical or different and is hydrogen or a monovalent, substituted or unsubstituted C₁-C₁₀ hydrocarbyl radical or C₁-C₁₀ aminohydrocarbyl radical and

R⁷ is a divalent C₁-C₁₅ hydrocarbyl radical

Examples of radical R⁶ are the examples already disclosed above, of hydrocarbyl radicals and also of hydrocarbyl radicals substituted by amino groups, such as aminoalkyl radicals, particular preference being given to the aminoethyl radical.

There is preferably at least one hydrogen atom bonded to each nitrogen atom in the radicals of the general formula (3).

Radical R⁷ preferably comprises divalent hydrocarbyl radicals having 1 to 10 carbon atoms, more preferably 1 to 4 carbon atoms, more particularly the n-propylene radical.

Examples of radical R⁷ are the methylene, ethylene, propylene, butylene, cyclohexylene, octadecylene, phenylene and butylene radicals.

Preferred examples of radicals R⁴ are

H₂N(CH₂)₃—,

H₂N(CH₂)₂NH(CH₂)₂—,

H₂N(CH₂)₂NH(CH₂)₃—,

H₂N(CH₂)₂—,

H₃CNH(CH₂)₃—,

C₂H₅NH(CH₂)₃—,

H₃CNH(CH₂)₂—,

C₂H₅NH(CH₂)₂—,

H₂N(CH₂)₄—,

H₂N(CH₂)₅—,

H(NHCH₂CH₂)₃—,

C₄H₉NH(CH₂)₂NH(CH₂)₂—,

cyclo-C₆H₁₁NH(CH₂)₃—,

cyclo-C₆H₁₁NH(CH₂)₂—,

(CH₃)₂N(CH₂)₃—,

(CH₃)₂N(CH₂)₂—,

(C₂H₅)₂N(CH₂)₃— and

(C₂H₅)₂N(CH₂)₂—.

The examples of alkyl radicals R¹ are valid in full for radical R⁷ as well.

Examples and preferred examples of the radical R⁵ are C1-C6 radicals listed above for radical R¹. Especially preferred are the methyl and the ethyl radical.

The preferred average value for a is 0 to 2, more particularly 0 to 1.8.

The preferred average value for b is 0.1 to 0.6, more particularly 0.15 to 0.30.

The preferred average value for c is 0 to 0.8, more particularly 0.01 to 0.6.

The organopolysiloxanes (B) preferably have a viscosity of 5 to 5000, more preferably of 100 to 3000 mm²/s at 25° C.

Organopolysiloxanes (B) can be prepared in a known way, for example by equilibration and/or condensing of amino-functional silanes with organopolysiloxanes which contain alkoxy groups and/or hydroxyl groups and which are free of basic nitrogen.

Preferably (B) is present in the silicone resin dispersion at 0.05-2 wt %, more preferably at 0.1-1.5 wt %.

### (C) Dispersing Assistants

The aqueous silicone resin dispersion comprises dispersing assistants (C) as identified, for example, in 2006 McCutcheon's Emulsifiers & Detergents, North American Edition, MC Publishing Co., Glen Rock, N.J. Particularly suitable in this context are
as anionic emulsifiers (C1):
1. Alkyl sulphates, especially those having a chain length of 8 to 18 C atoms, alkyl and alkaryl ether sulphates having 8 to 18 C atoms in the hydrophobic radical and 1 to 40 ethylene oxide (EO) and/or propylene oxide (PO) units.
2. Sulphonates, particularly alkylsulphonates having 8 to 18 C atoms, alkylarylsulphonates having 8 to 18 C atoms, taurides, full esters and monoesters of sulphosuccinic acid with monohydric alcohols or alkylphenols having 4 to 15 C atoms; these alcohols or alkylphenols may optionally also be ethoxylated with 1 to 40 EO units.
3. Alkali metal salts and ammonium salts of carboxylic acids having 8 to 20 C atoms in the alkyl, aryl, alkaryl or aralkyl radical.
4. Phosphoric partial esters and their alkali metal and ammonium salts, especially alkyl and alkaryl phosphates having 8 to 20 C atoms in the organic radical, alkyl ether phosphates and alkaryl ether phosphates having 8 to 20 C atoms in the alkyl or alkaryl radical, respectively, and 1 to 40 EO units.
as non-ionic emulsifiers (C2):
5. Polyvinyl alcohol additionally having 5% to 50%, preferably 8% to 20%, of vinyl acetate units, with a degree of polymerization of 500 to 3000.
6. Alkyl polyglycol ethers, preferably those having 8 to 40 EO units and alkyl radicals of 8 to 20 C atoms.
7. Alkylaryl polyglycol ethers, preferably those having 8 to 40 EO units and 8 to 20 C atoms in the alkyl and aryl radicals.
8. Ethylene oxide/propylene oxide (EO/PO) block copolymers, preferably those having 8 to 40 EO and PO units.
9. Adducts of alkylamines having alkyl radicals of 8 to 22 C atoms with ethylene oxide or propylene oxide.
10. Fatty acids having 6 to 24 C atoms.
11. Alkylpolyglycosides of the general formula R*O—Zₒ, in which R* is a linear or branched, saturated or unsaturated alkyl radical having on average 8-24 C atoms and Zₒ is an oligoglycoside residue having on average o=1-10 hexose or pentose units or mixtures thereof.
12. Natural substances and derivatives thereof, such as lecithin, lanolin, saponins, cellulose; cellulose alkyl ethers and carboxyalkylcelluloses whose alkyl groups possess in each case up to 4 carbon atoms.
13. Linear organo(poly)siloxanes containing polar groups, especially those having alkoxy groups with up 24 C atoms and/or up to 40 EO and/or PO groups.
as cationic emulsifiers (C3):
14. Salts of primary, secondary and tertiary fatty amines having 8 to 24 C atoms with acetic acid, sulphuric acid, hydrochloric acid and phosphoric acids.
15. Quaternary alkylammonium and alkylbenzeneammonium salts, especially those whose alkyl groups possess 6 to 24 C atoms, more particularly the halides, sulphates, phosphates and acetates.
16. Alkylpyridinium, alkylimidazolinium and alkyloxazolinium salts, especially those whose alkyl chain possesses up to 18 C atoms, especially the halides, sulphates, phosphates and acetates.
as ampholytic emulsifiers (C4):
17. Amino acids with long-chain substitution, such as N-alkyl-di(aminoethyl)glycine or N-alkyl-2-aminopropionoic salts.
18. Betaines, such as N-(3-acylamidopropyl)-N,N-dimethylammonium salts having a C8-C18 acyl radical, and alkylimidazolium betaines.

Preferred dispersing assistants are non-ionic emulsifiers (C2), especially the adducts of alkylamines with ethylene oxide or propylene oxide listed above under 9. the alkylpolyglycosides listed above under 11. and the polyvinyl alcohol listed above under 5. Particularly preferred polyvinyl alcohols also contain 5% to 20%, more particularly 10% to 15%, of vinyl acetate units and preferably have a degree of polymerization of 500 to 3000, more particularly of 1200 to 2000.

The fraction of the dispersing assistant (C) is preferably 1 to 30 wt %, more preferably 2 to 10 wt %, based on the total amount of silicone resin dispersion.

### Water (D)

The aqueous silicone resin dispersions of the invention further comprise water (D), preferably at 10 to 70 wt %, more preferably 15 to 60 wt %, based on the total amount of silicone resin dispersion.

### Auxiliaries (E)

As auxiliaries (E) it is possible to use all auxiliaries which are useful, such as, for example, emulsifiers for the homogeneous, stable dispersing of the silicone resin preparation in water. Further auxiliaries are, for example, silicone resins which differ from (A) or polyorganosiloxanes which differ from (B), silanes which differ from (F), organic solvents, wetting assistants, film-forming assistants, antifoams, adhesion promoters, flow control agents, crosslinking catalysts, pH modifiers, preservatives and solubilizers.

The fraction of the auxiliaries (E) is preferably 0.1 to 10 wt %, more particularly 0.1 to 8 wt %, based on the total amount of the silicone resin dispersion.

Alkylalkoxysilane (F) The C₁-C₂₀ alkyl-C1-C6 alkoxysilanes (F) preferably possess 1 or 2 identical or different, optionally halogen-substituted, SiC-bonded, monovalent C₁-C₂₀ alkyl radicals, and the remaining radicals are identical or different to C1-C6 alkoxy radicals, especially C₂ or C₃ alkoxy radicals. Particularly preferred are the alkyltrialkoxysilanes, such as octyltriethoxysilane and butyltriethoxysilane.

Examples of C₂-C₃ alkoxy radicals are the ethoxy, n-propoxy, and isopropoxy radicals. Ethoxy radicals are particularly preferred.

Methoxysilanes hydrolyse too quickly for many applications and have less storage stability than longer alkoxy radicals. For many applications, C₄-C₆ alkoxy radicals are too sluggish in reaction.

Examples of the C₁-C₂₀ alkyl radicals in (F) are the methyl, ethyl, n-propyl, isopropyl, n-butyl, isobutyl, tert-butyl, n-pentyl, isopentyl, neopentyl, and tert-pentyl radicals; hexyl radicals such as the n-hexyl radical; heptyl radicals such as the n-heptyl radical; octyl radicals such as the n-octyl radical and isooctyl radicals such as the 2,2,4-trimethylpentyl radical; nonyl radicals such as the n-nonyl radical; decyl radicals such as the n-decyl radical and dodecyl radicals, such as the n-dodecyl radical; cycloalkyl radicals such as cyclopentyl, cyclohexyl, 4-ethylcyclohexyl, cycloheptyl, norbornyl, and methylcyclohexyl radicals.

Examples of halogen-substituted C₁-C₂₀ alkyl radicals are alkyl radicals substituted by fluorine, chlorine, bromine, and iodine atoms, such as the 3,3,3-trifluoro-n-propyl radical, the 2,2,2,2′,2′,2′-hexafluoroisopropyl radical, and the heptafluoroisopropyl radical.

Particularly preferred are the unsubstituted C₄-C₁₂ alkyl radicals.

If the (C₁-C₂₀)-alkyl-(C₂-C₃)-alkoxysilane (F) which acts as priming impregnating agent is present in the organopolysiloxane dispersion of the invention, it is preferably included in amounts of 0.05 to 0.95%, based on the overall aqueous preparation of the coating material. (F) is included preferably at between 0.1 to 0.8 wt %, more preferably 0.1 to 0.5 wt %, in the aqueous coating material.

A further subject of the invention are coatings produced by using the aqueous coating materials of the invention.

The aqueous silicone resin dispersions of the invention are suitable not only for impregnating porous substances, of the kind employed, for example, in the electrical insulant sector (e.g., glass fabric, mica), but also as casting and embedding compounds. On account of the mild curing conditions, the aqueous silicone resin dispersions of the invention have advantages in particular in processing together with temperature-sensitive components (e.g., electronic components, casting moulds).

The aqueous silicone resin dispersions of the invention may also serve, furthermore, for manipulating further properties of preparations comprising them, or of solid bodies or films obtained from aqueous polyorganosiloxane dispersions of the invention, such as, for example:
controlling the electrical conductivity and the electrical resistance,
controlling the flow properties of a preparation,
controlling the gloss of a wet or cured film or of an article,
increasing the weathering resistance,
increasing the chemical resistance,
increasing the shade stability,
reducing the propensity to chalking,
reducing or increasing the static and sliding friction on solid bodies or films obtained from preparations comprising an aqueous polyorganosiloxane dispersion of the invention,
stabilizing or destabilizing foam in the preparation comprising aqueous polyorganosiloxane dispersions of the invention,
improving the adhesion of the preparation comprising an aqueous polyorganosiloxane dispersion of the invention to substrates,
controlling the filler and pigment wetting and dispersing behaviour,
controlling the rheological properties of the preparation comprising an aqueous polyorganosiloxane dispersion of the invention,
controlling the mechanical properties, such as flexibility, scratch resistance, elasticity, extensibility, bendability, tensile behaviour, resilience, hardness, density, tear resistance, compression set, behaviour at different temperatures, coefficient of expansion, abrasion resistance, and also further properties such as the thermal conductivity, combustibility, gas permeability, resistance to water vapour, hot air, chemicals, weathering, and radiation, and sterilizability, of solid bodies or films obtainable from preparations comprising an aqueous polyorganosiloxane dispersion of the invention,
controlling the electrical properties, such as breakdown strength, creep resistance, arc resistance, surface resistance, specific breakdown resistance, flexibility, scratch resistance, elasticity, extensibility, bendability, tensile behaviour, resilience, hardness, density, tear resistance, compression set, behaviour at different temperatures of solid bodies or films obtainable from the preparation comprising aqueous polyorganosiloxane dispersions of the invention.

Examples of applications in which the aqueous silicone resin dispersions of the invention can be used in order to manipulate the properties identified above are the production of coating materials and impregnations and of coatings and coverings obtainable therefrom on substrates, such as metal, glass, wood, mineral substrate, synthetic fibres and natural fibres for producing textiles, carpets, floor coverings, or other products producible from fibres, leather, plastics such as films, mouldings. With appropriate selection of the preparation components, the aqueous silicone resin dispersions of the invention may be further employed in preparations as additives for defoaming, promoting flow, hydrophobizing, hydrophilizing, dispersing of filler and pigment, wetting of filler and pigment, substrate wetting, promotion of surface smoothness, reduction of static and sliding friction on the surface of the fully cured material obtainable from the additized preparation. The aqueous silicone resin dispersions of the invention can be incorporated in liquid form or in fully cured solid form into elastomer materials. In this context they can be used for reinforcing or for improving other service properties such as the control of transparency, heat resistance, yellowing propensity, and weathering resistance.

### EXAMPLES

In the examples which follow, all parts and percentages data, unless otherwise indicated, relate to weight. Unless otherwise indicated, the examples below are carried out under the pressure of the surrounding atmosphere, in other words approximately at 1013 mbar, and at room temperature, in other words at approximately 25° C., or at a temperature which comes about when the reactants are combined at room temperature without additional heating or cooling. All viscosity data given in the examples relate to a temperature of 25° C. The solids content of the emulsions identifies the sum total of all components apart from water. Me denotes a methyl radical (—CH₃). Ph denotes a phenyl radical (—C₆H₅). Et denotes an ethyl radical (—CH₂—CH₃). ⁱOct denotes an isooctyl radical=2,2,4-trimethylpentyl radical. “I.” denotes inventive and “N.I.” denotes noninventive.

### Example 1: Production of an Inventive and of a Noninventive Aqueous Silicone Resin Dispersion

Using the components set out in tabular form below, an inventive silicone resin dispersion is made in analogy to the prior art, as described in EP1583790B1, and also a noninventive dispersion. The quantities employed are reported in Table 1.

TABLE 1

| | Chemical identity/ | | |
|---|---|---|---|
| Components | manufacturer | I. | N.I. |
| Arlypon IT 5 | Polyoxyethylene (5) | 5.64 g | 5.64 g |
| | isotridecyl ether | | |
| | (nonionic emulsifier, | | |
| | manufacturer Cognis | | |
| | GmbH, Illertissen) | | |
| Arlypon IT 10 | Polyoxyethylene (10) | 7.08 g | 7.08 g |
| | isotridecyl ether | | |
| | (nonionic emulsifier, | | |
| | manufacturer Cognis | | |
| | GmbH, Illertissen) | | |
| Water | | 12.18 + | 12.18 + |
| | | 100.14 g | 100.14 g |
| Aminosilicone | 50 weight percent | 2.85 g | 2.85 g |
| oil emulsion | aqueous dispersion of a | | |
| | polydiorganosiloxane, | | |
| | 99.3% of whose organic | | |
| | groups are methyl | | |
| | groups and 0.7% of | | |
| | whose organic groups | | |
| | are N-(2-aminoethyl)-3- | | |
| | amino-n-propyl groups | | |
| | and whose viscosity at | | |
| | 25° C. is 450 mm²/s | | |
| N.I. Silicone | 1. Silicone resin 1, | 0.0 g | 171.0 |
| resin | consisting of 90 mol % | | |
| preparation | MeSiO_{3/2} units (= T | | |
| possessing | units) and 10 mol % | | |
| only one kind | Me₂SiO_{2/2} units, with | | |
| of repeating | 8 mol % of EtO radicals | | |
| units of the | and 2 mol % of silicon- | | |
| formula (1) | bonded HO radicals | | |
| and no | being distributed over | | |
| mixture of at | the T and D units, | | |
| least two | thereby giving the | | |
| such units | meaning of R⁷, and | | |
| having | 2. Silicone resin 2, | | |
| different | consisting of 100% of | | |
| hydrocarbon | MeSiO_{3/2} units (= T | | |
| substituents: | units), with 20 mol % of | | |
| | EtO radicals being | | |
| | distributed randomly | | |
| | over the T units of | | |
| | silicone resin 2, there | | |
| | being 80 percent by | | |
| | weight of silicone | | |
| | resin 1 and 20 percent | | |
| | by weight of silicone | | |
| | resin 2 in the mixture, and | | |
| | 3. Calculated on the | | |
| | mass of silicone resin | | |
| | 1, 10% by weight of | | |
| | triethoxyisooctyl | | |
| | silane, | | |
| | the siloxane-silane | | |
| | preparation being in | | |
| | dispersion in water and | | |
| | the fraction thereof in | | |
| | 100% of the dispersion | | |
| | being 50 percent by | | |
| | weight | | |
| I. Silicone | Silicone resin composed | 171.00 g | 0.0 g |
| resin | of 90 mol % MeSiO_{3/2} | | |
| | units and 10 mol % | | |
| | ⁱOctSiO_{3/2} units, with | | |
| | 18 mol % of EtO radicals | | |
| | and 1 mol % of HO | | |
| | radicals being | | |
| | distributed randomly | | |
| | over these T units | | |
| Konservierer | 10% solution of 2- | 0.15 g | 0.15 g |
| MIT 10 | methyl-4-isothiazolin- | | |
| | 3-one in water | | |
| | (preservative, | | |
| | manufacturer Rohm and | | |
| | Haas) | | |
| PARMETOL | Mixture of 5-chloro-2- | 0.72 g | 0.72 g |
| A 28 S | methyl-2H-isothiazol-3- | | |
| | one (CAS 26172-55-4) | | |
| | and 2-methyl-2H- | | |
| | isothiazol-3-one (CAS | | |
| | 2682-20-4) | | |
| | (Preservative, | | |
| | manufacturer Schülke & | | |
| | Mayr GmbH, Norderstedt) | | |
| Triethanol- | Triethanolamine | 0.24 g | 0.24 g |
| amine | | | |

### Example 2: Inventive and Noninventive Architectural Preservative Coating with Supercritical Pigment Volume Concentration (PVC)

The following components were combined by mixing using a high-speed Rotor Stator mixer of customary commercial form, to give an inventive and a noninventive architectural preservative coating. The quantities employed are reported in Table 2.

TABLE 2

| | I. | N.I. |
|---|---|---|
| | Quantities | Quantities |
| Component | in g | in g |
| Water | 310 | 310 |
| In-can preservative | 2.0 | 2.0 |
| Film preservative | 10.0 | 10.0 |
| Cellulose thickener | 3.0 | 3.0 |
| PU thickener | 2.0 | 2.0 |
| Polyphosphate, sodium salt | 2.0 | 2.0 |
| Polyacrylate, sodium salt | 2.0 | 2.0 |
| Silicone antifoam | 3.0 | 3.0 |
| Titanium dioxide pigment | 120.0 | 120.0 |
| Silicatic filler | 80.0 | 80.0 |
| Talc | 40.0 | 40.0 |
| Calcium carbonate | 215.0 | 215.0 |
| Matting filler | 12.0 | 12.0 |
| Sodium hydroxide solution, 10% | 1.0 | 1.0 |
| Film-forming assistant | 10.0 | 10.0 |
| I. aqueous silicone resin | 83.0 | 0 |
| preparation as per Example 1 | | |
| N.I. aqueous silicone resin | 0 | 83.0 |
| preparation as per Example 1 | | |
| Styrene acrylate dispersion, 50% in | 95.0 | 95.0 |
| water, with a styrene to butyl | | |
| acrylate ratio such as to produce a | | |
| minimum film-forming temperature of | | |
| 15° C. for the polymer | | |
| Total: | 990 | 990 |

The formula results in an inventive and a noninventive porous coating, since the pigment volume concentration (PVC) thereof is above the critical PVC.

### Example 3: Performance Tests of the Inventive and of the Noninventive Construction Coating from Example 2

Testing of the construction coatings from Examples 2 for their service properties, in accordance with the standard specifications listed in Table 3:

TABLE 3

| | Test standard |
|---|---|
| Unconditioned water permeability rate (w₂₄ | Measurement to ISO |
| in kg/m²h^{0.5}) | 1062-3 but without |
| | prior conditioning |
| Water permeability rate (w₂₄ in kg/m²h^{0.5}) | ISO 1062-3 |
| Scrub resistance after conditioning: | Measurement to DIN |
| storage for 4 d under standard conditions of | 53778-2 |
| 23° C. and 50% relative humidity | |
| Scrub resistance after 200 h QUV-B | Measurement to DIN |
| weathering | 53778-2 |
| Surface hydrophobicity through beading | In-house testing |
| effect | protocol |

### Procedure for Determining the Surface Hydrophobicity:

One droplet of water (volume 1 ml) is applied from a pipette to the surface under test. After 10 minutes, visual examination evaluates how effectively the droplet wets the surface.

### Evaluation System:

1=substrate is not wetted, and water droplet beads off completely and without residue from an inclined surface (slope 30° relative to the plane)

2=good beading effect but individual small droplets of water remain hanging on the surface

3=substrate is partly wetted, with water droplet beading off incompletely

4=substrate is wetted, and the water droplet no longer beads off

5=substrate is wetted, and the water droplet spreads

The results obtained are set out in Table 4.

TABLE 4

| | | I. |
|---|---|---|
| | N. I. | Construction |
| | Coating from | coating from |
| | Example 2 | Example 2 |
| Uncond. w₂₄ in kg/m²h^{0.5} | 0.23 | 0.07 |
| w₂₄ in kg/m²h^{0.5} | 0.09 | 0.06 |
| Scrub resistance after | 8600 | >10 000 |
| conditioning | | |
| Scrub resistance after QUV-B | >10 000 | >10 000 |
| Surface hydrophobicity | 1 | 4 |

When using the aqueous silicone resin dispersion of the invention, it is observed that the water permeability rate is very low even without conditioning. This low rate is maintained after conditioning. The scrub resistance of the paint comprising the aqueous silicone resin dispersion of the invention is already at the highest level defined by the specified standard after simple conditioning. This level is maintained after weathering. The most conspicuous effect brought about by the aqueous silicone resin dispersion of the invention is the surprising and new combination of low water permeability in conjunction with low surface hydrophobicity. Since the paint formulations consist of the same components in the same proportions, this effect can be explained only by the difference in behaviour between the inventive and the noninventive silicone resin dispersion.

### Example 4: Production of an Inventive and of a Noninventive Aqueous Silicone Resin Dispersion

An inventive silicone resin dispersion is manufactured in analogy to the noninventive dispersion in accordance with the prior-art description in EP1583790B1, from the constituents listed in tabular form below. The quantities employed are reported in Table 5.

TABLE 5

| | Chemical identity/ | | |
|---|---|---|---|
| Components | manufacturer | I. | N.I. |
| Arlypon IT 16 | Polyoxyethylene (16) | 6.0 g | 6.0 g |
| (80% aqueous | isotridecyl ether | | |
| solution) | (nonionic emulsifier, | | |
| | manufacturer Cognis | | |
| | GmbH, Illertissen) | | |
| Water | | 3.5 + | 3.5 + |
| | | 38.24 g | 38.24 g |
| E. Silicone | Silicone resin | 52.0 g | 0.0 g |
| resin | composed of 95 mol % | | |
| | MeSiO_{3/2} units and | | |
| | 5 mol % PhSiO_{3/2} units, | | |
| | with 17 mol % of EtO | | |
| | radicals and 1.6 mol % | | |
| | of HO radicals | | |
| | distributed randomly | | |
| | over these T units | | |
| N.I. Silicone | 1. Silicone resin 1, | 0.0 g | 52.0 g |
| resin | consisting of 90 mol % | | |
| | MeSiO_{3/2} units (= T | | |
| | units) and 10 mol % | | |
| | Me₂SiO_{2/2} units, with | | |
| | 8 mol % of EtO | | |
| | radicals and 2 mol % | | |
| | of silicon-bonded HO | | |
| | radicals being | | |
| | distributed over the | | |
| | T and D units, | | |
| | thereby giving the | | |
| | meaning of R⁷, and | | |
| | 2. Silicone resin 2, | | |
| | consisting of 100% of | | |
| | MeSiO_{3/2} units (= T | | |
| | units), with 20 mol % | | |
| | of EtO radicals being | | |
| | distributed randomly | | |
| | over the T units of | | |
| | silicone resin 2, | | |
| | there being 80 | | |
| | percent by weight of | | |
| | silicone resin 1 and | | |
| | 20 percent by weight | | |
| | of silicone resin 2 | | |
| | in the mixture, and | | |
| | 3. Calculated on the | | |
| | mass of silicone | | |
| | resin 1, 10% by | | |
| | weight of | | |
| | triethoxyisooctyl | | |
| | silane, | | |
| | the siloxane-silane | | |
| | preparation being in | | |
| | dispersion in water | | |
| | and the fraction | | |
| | thereof in 100% of | | |
| | the dispersion being | | |
| | 50 percent by weight | | |
| Konservierer | 10% solution of 2- | 0.1 g | 0.1 g |
| MIT 10 | methyl-4- | | |
| | isothiazolin-3-one in | | |
| | water (preservative, | | |
| | manufacturer Rohm and | | |
| | Haas) | | |
| PREVENTOL ®BIT 10 | 10% strength alkaline | 0.1 g | 0.1 g |
| | solution of 1,2- | | |
| | benzisothiazolin-3- | | |
| | one (preservative, | | |
| | manufacturer LANXESS) | | |
| Triethanolamine | Triethanolamine | 0.06 g | 0.06 g |

### Example 5: Inventive and Noninventive Construction Coating Using the Inventive and the Noninventive Aqueous Silicone Resin Dispersions from Example 4

The following components were combined by mixing using a high-speed Rotor Stator mixer of customary commercial form, to give an inventive and a noninventive architectural preservative coating (aqueous coating material). The quantities employed are reported in Table 6.

TABLE 6

| | I. | N.I. |
|---|---|---|
| | Quantity | Quantity |
| Component | [g] | [g] |
| Water | 353.9 | 353.9 |
| In-can preservative | 2.0 | 2.0 |
| Film preservative | 10.0 | 10.0 |
| Cellulose thickener | 3.0 | 3.0 |
| PU thickener | 2.0 | 2.0 |
| Polyphosphate, sodium salt | 2.0 | 2.0 |
| Polyacrylate, sodium salt | 2.0 | 2.0 |
| Silicone antifoam | 4.0 | 4.0 |
| Titanium dioxide pigment | 117.0 | 117.0 |
| Silicatic filler | 78.0 | 78.0 |
| Talc | 39.0 | 39.0 |
| Calcium carbonate | 209.5 | 209.5 |
| Matting filler | 11.5 | 11.5 |
| Sodium hydroxide solution, 10% | 1.1 | 1.1 |
| Inventive aqueous silicone resin | 40.0 | 0.0 |
| preparation as per Example 4 | | |
| Noninventive aqueous silicone resin | 0.0 | 40.0 |
| dispersion as per Example 4 | | |
| Vinyl acetate-ethylene copolymer | 125.0 | 125.0 |
| dispersion, 60% in water | | |
| Total: | 1000 | 1000 |

The formula results in an inventive and a noninventive porous coating, since the pigment volume concentration (PVC) thereof is above the critical PVC.

### Example 6: Performance Tests of the Inventive and of the Noninventive Construction Coating from Example 5

The testing of the construction coatings from Examples 5 for their service properties takes place in analogy to Example 3.

The results obtained are shown in Table 7.

TABLE 7

| | N. I. | I. Construction |
|---|---|---|
| | Coating from | coating from |
| | Example 5 | Example 5 |
| Uncond. w₂₄ in kg/m²h^{0.5} | 0.72 | 0.25 |
| w₂₄ in kg/m²h^{0.5} | 0.17 | 0.15 |
| Scrub resistance after | 8456 | >10,000 |
| conditioning | | |
| Scrub resistance after QUV-B | >10,000 | >10,000 |
| Surface hydrophobicity | 1 | 5 |

When using the aqueous silicone resin dispersion of the invention, it is observed that the water permeability rate is much lower even without conditioning than in the case of the comparable noninventive construction coating. This low rate is maintained after conditioning. The scrub resistance of the paint comprising the aqueous silicone resin dispersion of the invention is already at the highest level defined by the specified standard after simple conditioning. This level is maintained after weathering. The most conspicuous effect brought about by the aqueous silicone resin dispersion of the invention is the surprising and new combination of low water permeability in conjunction with low surface hydrophobicity. Since the paint formulations consist of the same components in the same proportions, this effect can be explained only by the difference in behaviour between the inventive and the noninventive silicone resin dispersion.

1.-9. (canceled)

10. An aqueous silicone resin dispersion, comprising
(A) 10-70 wt % of at least one silicone resin liquid at room temperature (25° C.), comprising
at least 50% of repeating units of the formula (1)
R¹(R²O)_{b}SiO_{(3-b/2)} (1)
where
R¹ each independently are C1-C20 hydrocarbyl radicals which carry no or one or more heteroatoms,
R² each independently are C1-C6 hydrocarbyl radicals or a hydrogen radical, and b has a value of 0, 1 or 2,
and 0 to at most 50% of repeating units of the formula (2),
R⁸_{c}(R²O)_{d}SiO_{(4-c-d/2)} (2),
where
R⁸ each independently at each occurrence are C1-C20 hydrocarbyl radicals,
R² has the definition stated above,
c is 0, 2 or 3,
d is 0, 1, 2 or 3,
with the proviso that c+d≦3,
wherein
the silicone resins comprise at least 2 repeating units of the formula (1), which are different from one another, in a ratio of 1:100 to 100:1, and which carry at least 2 radicals R¹ which are different from one another and which differ from one another in their length or size by at least one hydrocarbon unit, 5% to 35% of all silicon-bonded substituents in formula (1) are of the subformula (R²O) in which R² is a C1-C6 hydrocarbyl radical, at most 5% of all silicon-bonded substituents in formula (1) are of the subformula (R²O) in which R² is a hydrogen radical, in at least 5% of all the repeating units of the formula (1), b=0, in at least 5% of all the repeating units of the formula (1), b=1, and in at most 25% of all the repeating units of the formula (1), b=2
B) 0-2 wt % of one or more organopolysiloxanes comprising SiC-bonded radicals with basic nitrogen, with the proviso that the amine number of the organopolysiloxanes with basic nitrogen is at least 0.01,
(C) 0.1-30 wt % of at least one dispersing assistant,
(D) 10-70 wt % of water,
(E) 0.01-10 wt % of at least one auxiliary, and
(F) 0 to 6 wt % of at least one alkylalkoxysilane whose alkyl radicals are C1-C20 alkyl radicals and whose alkoxy groups consist of oxygen-bonded C1-C6 alkyl radicals.

11. The aqueous silicone resin dispersion of claim 10, wherein R¹ is selected from C1-C20 alkyl radicals without heteroatoms, and aryl radicals.

12. The aqueous silicone resin dispersion of claim 10, wherein R¹ is selected from C1-C20 alkyl radicals without heteroatoms.

13. The aqueous silicone resin dispersion of claim 10, wherein R¹ is selected from the group consisting of methyl, ethyl, n-octyl, isooctyl radicals, and mixtures thereof.

14. The aqueous silicone resin dispersion of claim 10, wherein R¹ are methyl and isooctyl radicals.

15. The aqueous silicone resin dispersion of claim 10, wherein R¹ is selected such that there is a combination of at least one C1-C20 alkyl radical without heteroatoms with at least one aryl radical.

16. The aqueous silicone resin dispersion of claim 10, wherein R¹ are methyl and phenyl radicals.

17. Aqueous coating materials, comprising at least one silicone resin dispersion of claim 10.

18. The aqueous coating materials of claim 17, which is a paint, stain, varnish or render.
